(19) United States
(12) Patent Application Publication
(10) Pub. No.: US 2017/0278351 A1
(43) Pub. Date: Sep. 28, 2017

(54) Lottery Gaming System And Method For Reducing Debt Of An Individual

(71) Applicant: Dominic Family Trust, Las Vegas, NV (US)

(72) Inventor: Dennis Dominic, Las Vegas, NV (US)

(21) Appl. No.: 15/220,416

(22) Filed: Jul. 27, 2016

Related U.S. Application Data
(60) Provisional application No. 62/312,089, filed on Mar. 23, 2016.

(51) Int. Cl. G07F 17/32

(52) U.S. Cl. CPC G07F 17/3255; G07F 17/329; G07F 17/3272; G07F 17/3225; G07F 17/3211

(57) ABSTRACT

A lottery gaming system and method for reducing debt of an individual is provided. The lottery gaming system and method for reducing debt of an individual may include a website for registering the individual and designating a pre-qualified debt associated with a creditor and an approved charitable organization to participate in the lottery game. The website may provide a ticket with a corresponding ID number associated with the individual and may further select a winning ticket. If the individual's ticket is selected, then the monetary prize is transmitted to the creditor of the pre-qualified debt. If the monetary prize is greater than the pre-qualified debt, then a remainder of the monetary prize is transmitted to the approved charitable organization.

### CROSS-REFERENCE TO RELATED APPLICATIONS

This application claims benefit of application serial number U.S. Provisional Application No. 62/312,089 filed on Mar. 23, 2016, which is hereby incorporated by reference as though set forth fully herein.

### FIELD OF DISCLOSURE

The present disclosure generally relates to a lottery gaming system and method for reducing an individual's debt, and in particular, a lottery gaming system and method for reducing an individual's debt where the monetary prize is automatically paid to one or more of the individual's creditors and any remaining prize in excess of the individual's debt is donated to a charitable organization designated by the individual from a vetted list of nationally know and charities; the winner receiving the tax benefit and vetted charities prevent any “gaming” of the lottery rules and intent.

### BACKGROUND OF THE DISCLOSURE

Games of chance such as lotteries, raffles, and sweepstakes are played by individuals for fun and entertainment, and are well-known. Typically, these games require an individual to purchase a raffle ticket or a ticket comprising a set of numbers to be eligible to win a monetary prize or an item worth some monetary value. For the individual to win the prize, the corresponding raffle ticket or set of matching numbers must be drawn. If the individual wins, they may collect the prize and use it as they desire. However, the odds of an individual winning the game are slim to none. For instance, in certain states, the odds for matching six numbers on a lottery ticket are 1 in 175,711,536. Similarly, the odds for matching five numbers on a lottery ticket are 1 in 3,904,700.8. Further, the odds of winning are not necessarily proportionate to the monetary prize. For example, if an individual matches five numbers, they may only receive $250,000 or less from a prize, perhaps worth hundreds of millions. As such, these types of lotteries are not always desirable.

However, other structures of these games exist. Unlike the typical games discussed above, the games may be played at events where the individual buys a ticket with the assumption that a portion of or the entire monetary prize will be donated to a charitable organization. In this instance, the individual may receive a portion of the prize and may do whatever they desire with the winnings including, keeping it and using it as they wish or donating it to the charity. However, neither is mandatory when purchasing the ticket. With respect to either scenario discussed above, there is no criterion to play these games or any constraints on how the individual may use the prize other than those imposed by law for purchasing a ticket.

Additionally, with the current state of the economy, individuals are not encouraged to play these types of games. Currently, a majority of individuals in this country have some sort of debt, often times, very burdensome debt, such as student loans, credit card, mortgage, medical and the like. Economic times and demographics have made it difficult for many of these individuals to pay off their debts and as a result, these individuals sacrifice their participation in building the fundamental elements of life, a home, some semblance of relief from a crushing and worrisome debt load, beginning or raising a family, merely enjoying a little fun and entertaining activities as well as are unable to provide funds to charitable organization in their surround community. Very few mechanisms exist to provide these individuals with relief and promote charity.

As a result, there is a need for a mechanism that would benefit individuals in debt and promote charity in the community as well as have entertainment value.

### SUMMARY OF THE DISCLOSURE

It is therefore an aspect of the present disclosure to provide a lottery gaming system and method of reducing debt through a lottery game.

According to the above and the other aspects, a lottery gaming system is provided. The lottery gaming system may include a website for registering and participating in a lottery game associated with a monetary prize. An individual can purchase a ticket associated with an identification (ID) number when the individual has a pre-qualified debt. The individual may designate a creditor related to the pre-qualified debt and may designate an approved charitable organization through the website. The website may also include a lottery interface for selecting the winning ticket. After the winning ticket is selected, the lottery gaming system may transmit the monetary prize to the creditor of the individual associated with the ticket to pay the individual's debt. Additionally, if the monetary prize exceeds the amount of the individual's debt, then the remainder of the monetary prize may be transmitted to the charitable organization.

Another aspect of the present disclosure many include a lottery gaming system for reducing debt of an individual through a lottery game associated with a wager amount and a prize amount corresponding to the wager amount. The lottery gaming system includes a computer program for allowing the individual to participate and register for the lottery game executed on a processor. The computer program includes a registration module for allowing the individual to select a pre-qualified debt associated with a creditor to receive the prize amount in the event the individual wins the lottery game and to select from a list approved charitable organizations to donate a remaining prize amount if the prize amount is greater than the pre-qualified debt, wherein the registration module generates a ticket for the individual for participation in the lottery game, a lottery module for selecting a winning ticket, wherein if the individual's ticket is the winning ticket, the lottery gaming system transmits the prize amount to the creditor of the pre-qualified debt, and if the prize amount is greater than the pre-qualified debt, then the remaining prize amount is transmitted to the approved charitable organization. Another aspect of the present disclosure includes a lottery gaming system for reducing debt of an individual. The lottery gaming system may include a lottery game executed on a processor and having at least one level of participation, each level of participation is associated with a pre-determined wager amount and a prize amount corresponding to the pre-determined wager. The individual registers for the lottery game by selecting the at least one level of participation, selecting a pre-qualified debt associated with an creditor, and selecting a pre-approved charitable organization. Additionally, the lottery game generates and provides a ticket to the individual based on the at least one level of participation, selects a winning ticket from a plurality of tickets, and transmits the prize amount to the creditor of the pre-qualified debt in response to individual's ticket being selected as the winning ticket, and wherein if the prize amount is greater than the individual's pre-qualified debt, then the remaining prize amount is transmitted to the charitable organization.

Another aspect relates to a method of reducing an individual's debt through a lottery game, including providing the lottery game associated with a monetary prize through a website, where the individual has a pre-qualified debt, where the individual has designated a creditor associated with the pre-qualified debt, and where the individual has designated an approved charitable organization to purchase a ticket and to participate in the lottery game. The ticket may have a corresponding ID number that is associated with the individual who purchased the ticket. The method may also include selecting a winning ticket through a lottery interface of the web site and transmitting the monetary prize to the creditor of the individual associated with the ID number of the ticket. If the monetary prize is greater than the individual's pre-qualified debt, then the remainder of the monetary prize is transmitted to the approved charitable organization.

Another aspect of the present disclosure may include a method of reducing debt of an individual utilizing a lottery gaming system. The lottery gaming system may include a computer program executed on a processor for enabling a lottery game associated a wager amount and a prize amount corresponding to the wager amount. The method may include providing a registration module for registering the individual for the lottery game, wherein the registration module allows the individual to select a creditor of a pre-qualified debt and an approved charitable organization, generating a ticket associated with the individual for the lottery game, selecting a winning ticket from a plurality of tickets, determining if the ticket associated with the individual is the winning ticket, and transmitting the prize amount to the creditor of the pre-qualified debt to pay the individual's debt if the winning ticket is the ticket associated with the individual, Further, if the prize amount is greater than the pre-qualified debt, then the remaining prize amount is transmitted to the approved charitable organization.

The aspects of the present disclosure provide various advantages. For example, the lottery game alleviates a portion or all of the winning individual's debt. Additionally, the lottery game contributes to the community through its donation to a preselected charity, in the event the winning or prize amount exceeds the winning individual's debt. The aspects of the present disclosure also offer incredibly improved odds of winnings compared to current lottery games. Further, the lottery game provides excitement, entertainment, and hope to any individual that plays.

### BRIEF DESCRIPTION OF THE FIGURES

Other aspects of the present disclosure will be readily appreciated, as the same becomes better understood by reference to the following detailed description when considered in connection with the accompanying drawings wherein:

FIG. 1 is a block diagram of a lottery gaming system for reducing debt of an individual in accordance with an aspect of the present disclosure;

FIG. 2 is an example of a table with various levels of participation associated with a lottery gaming system for reducing debt of an individual in accordance with an aspect of the present disclosure;

FIG. 3 is an example of a table with various odds associated with each level of participation of a lottery gaming system for reducing debt of an individual in accordance with an aspect of the present disclosure; and

FIG. 4 is a flowchart of a method of reducing debt of an individual utilizing a lottery game in accordance with an aspect of the present disclosure.

### DETAILED DESCRIPTION OF THE PRESENT DISCLOSURE

Detailed aspects of the present disclosure are provided herein; however, it is to be understood that the disclosed aspects are merely exemplary and may be embodied in various and alternative forms. It is not intended that these aspects illustrate and describe all possible forms of the disclosure. Rather, the words used in the specification are words of description rather than limitation, and it is understood that various changes may be made without departing from the spirit and scope of the disclosure. As those of ordinary skill in the art will understand, various features of the present disclosure as illustrated and described with reference to any of the Figures may be combined with features illustrated in one or more other Figures to produce examples of the present disclosure that are not explicitly illustrated or described. The combinations of features illustrated provide representative examples for typical applications. However, various combinations and modifications of the features consistent with the teachings of the present disclosure may be desired for particular applications or implementations. Additionally, the features and various implementing embodiments may be combined to form further examples of the disclosure.

A lottery gaming system and method for reducing or eliminating debt of an individual is provided. The lottery gaming system and method for reducing debt of an individual may include a website for registering the individual and designating a pre-qualified debt associated with a creditor and an approved charitable organization to participate in the lottery game. The website may provide a ticket with a corresponding identification (ID) number associated with the individual and may further select the winning ticket. If the individual's ticket is selected, then the monetary prize is transmitted to the creditor of the pre-qualified debt. If the monetary prize is greater than the pre-qualified debt, then the remainder of the monetary prize is transmitted to the approved charitable organization.

The lottery gaming system and method is designed to provide relief to those individual's that fall into specific categories of debt as well as to benefit the community. Specifically, the lottery is conducted in such a way that the winnings or prize is automatically designated to pay for a portion or all of the winning individual's debt given the participation level or specific game the individual is playing. More specifically, in operation, the lottery gaming system and method may allow the individual or debtor to register to participate in one or more lotteries associated with various odds based on the wager amounts or levels of participation. A winner is selected for each level of participation, each time an individual lottery is conducted. In registering for the lottery, the individual may select a pre-qualified category of debt to be paid as well as an approved charitable organization which may also be paid, in the event the lottery winnings exceed the pre-determined debt amount. This lottery gaming system and method is unique in itself that the individual cannot be eligible to participate within the lottery unless they fall within a pre-qualified category of debt. Additionally, this lottery gaming system and method is unique for the reason that it mandates the use of the individual's winnings, provides the individual financial relief, and promotes good will in the community by donating any excess winnings to a charity.

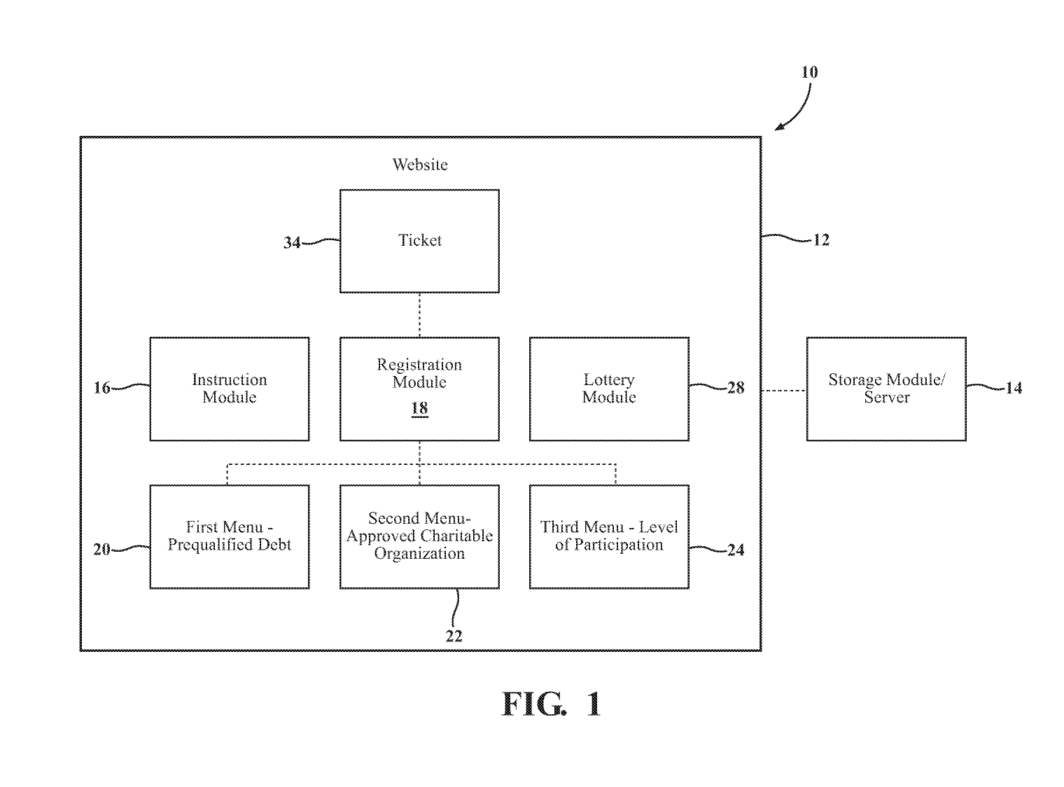

FIG. 1 is an illustration of a block diagram of a lottery gaming system 10 for reducing an individual's debt in accordance with an aspect of the present disclosure. The lottery gaming system 10 may have a website or a computer program 12 executable on a processor (not shown) accessible by individuals via the internet, mobile application, or by a standalone electronic kiosk located within a store, similar to known lottery games, which may be operated by the individual or by an attendant. The website 12 may consist of various modules to facilitate operation of the lottery gaming system 10.

The lottery gaming system 10 may include an instruction module 16. The instruction module 16 may include control logic relating to and for displaying information and instructions for participating in the lottery such as, but not limited to, applicable laws, types of wagers, levels of participation, odds of winning based on wagers, pre-qualified categories of debt, approved charitable organization, operation of the lottery, drawing of the winning set of numbers, contacting the winning individual, and payment of winnings. The instruction module 16 may also include terms and condition information in which the individual must agree to participate in the lottery.

The lottery gaming system 10 may also include a registration module 18. The registration module 18 may include control logic allowing one or more individuals to establish an account with the lottery gaming system 10. To establish an account, the individual may be directed to enter their personal information such as, but not limited to, their name, address, e-mail, phone number, social security number, and type of payment information. The individual may use a credit card, paypal, or any form of electronic payment to establish a wager in the lottery.

Additionally, the registration module 18 may have a first menu 20 for selecting a pre-qualified category of debt to be paid if the individual wins the lottery. The pre-qualified category of debt may be any one of the following: 1) credit card, 2) mortgage, 3) automobile, 4) student loans, or 5) medical/dental expenses. The first menu 20 may include an area for the individual to specify the creditor of the individual's debt as well as other relevant information to identify the a valid creditor such as an account number. The lottery gaming system 10 may also require the pre-qualified category of debt to be verified for the individual to be eligible for the lottery.

The registration module 18 may have a second menu 22 for selecting from a list of approved charitable organization for donating any remainder of the individual's winnings. The approved charitable organization can be a charity that is approved by the gaming commission associated with the lottery. For example, the charitable organization may be St. Jude's Children's Hospital or Shiner's Hospital.

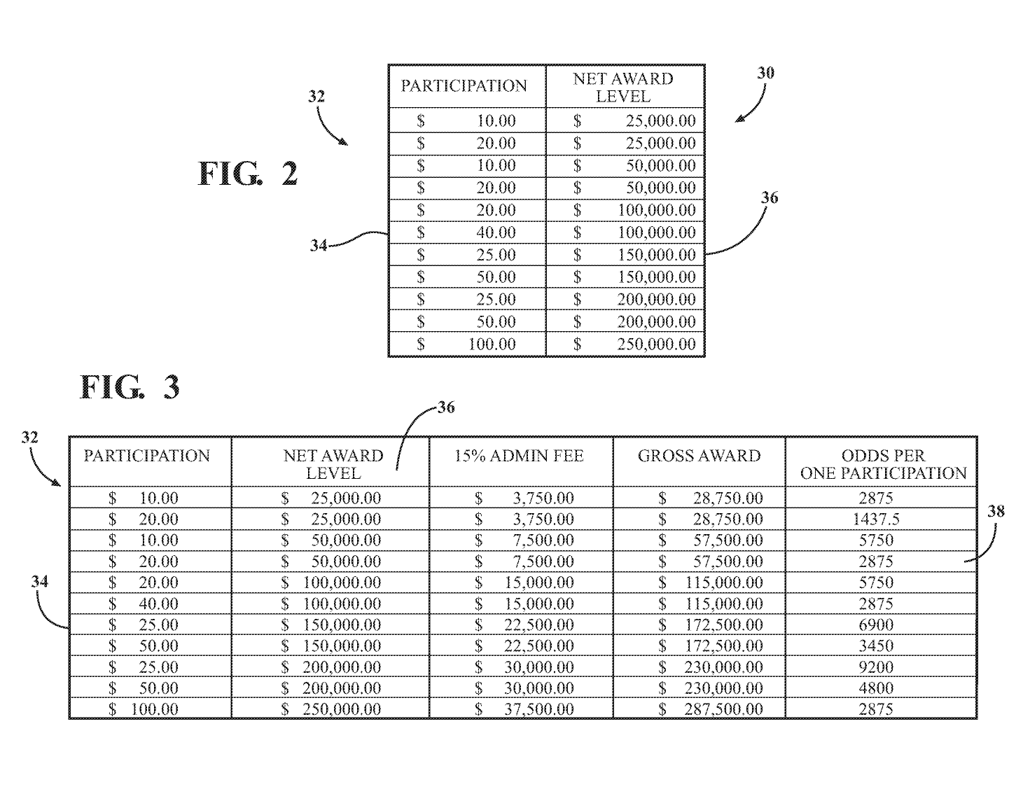

A third menu 24 may also be present for selecting a level of participation for engaging in the lottery. The level of participation may include up to a pre-determined number of lottery games based on the individual's wager, each having different odds of winning. The level of participation and odds of winning will be explained in greater detail in FIGS. 2 and 3. Once registration is complete, the registration module 18 transmits a notice to the individual's e-mail, text or instant message, for the individual to confirm registration. In response to the notice, the individual may be requested to post a testimonial or critique, positive or negative, regarding the lottery service on its website. A ticket 26 is then produced to the individual. The ticket 26 may be a physical paper or electronic ticket. The ticket 26 may have an identification (ID) number that is associated with the individual. The individual may not designate the ID number. Instead, the ID number may be individual's account or registration number. It is appreciated by one skilled in the art that the registration module 18 may be in communication with a storage module or a server 14. The storage module 14 may be designed to store the information of the individual including their payment information, the ticket information, and the information relating to their third party creditor for payment if the individual wins the lottery. Overall, the registration module 18 may be designed to vet the individual to ensure the individual is eligible to participate in one or multiple levels/games of the lottery gaming system 10.

The lottery gaming system 10 may further include a lottery module 28 where the lottery drawing occurs based on the individual's selected level of participation. Specifically, the tickets associated with each individual participating in that particular drawing may be placed in a virtual hopper such as a plurality of tickets. The winning ticket is then selected from the plurality of tickets. The lottery module 28 may include multiple virtual hoppers as multiple drawings and games may occur at the same time, each having a different level of participation such as odds and wager amount and each selecting a winning ticket. The lottery module 28 may be configured to electronically mix the tickets in a virtual hopper one or more times and may be configured to eliminate an amount of tickets to select the winning ticket. As a result, the odds of the individual winning may change as tickets are eliminated from the virtual hopper. For instance, all tickets for that level may be electronically mixed a first time and a second time before any tickets may be eliminated. Once the tickets are mixed, then half the tickets may be removed or eliminated. The remaining tickets may be mixed again and numbers may be eliminated until ten tickets remain. A winning ticket may then be selected from the remaining tickets. After a winning ticket is selected, the lottery module 28 may be configured to alert the individual based on the ID number corresponding to the ticket. Specifically, the lottery module 28 may alert the individual to of their winnings via e-mail.

In operation, when an individual's ticket is selected in the lottery module 28, the lottery gaming system 10 accesses the individual's information from the storage module 14 and transfers the winnings automatically to the creditor or third party of the pre-qualified debt within a pre-determined amount of time such as 72 hours. If the winnings are greater than the amount of the debt, then the remaining winnings or prize amount may be directly donated to the approved charitable organization designated in the individual's name. For example, if the individual filled out the registration for one or more level of participations in the lottery, indicated they have $45,000 in credit card debt to VISA, selected an approved charitable organization, wagers within the lottery where the winnings or prize amount is $50,000, and their ticket is selected as the winning ticket, then the lottery gaming system 10 automatically pays $45,000 to VISA and the remaining $5,000 to the selected charity. As a result, the individual experiences a sense of relief, good will, and entertainment and a tax deduction.

Alternatively, if the winnings or prize amount is less than the amount of the debt, that portion of the debt will be paid to the third party or creditor without payment to the charitable organization. The individual may then be limited in the number of times they may participate and win in the lottery over a pre-determined amount of time. For instance, the individual may not be permitted to win another lottery for 12 months. Additionally, the individual may be limited to a maximum number of participations during a pre-determined period of time and within a specific debt category. For example, the individual may only be allowed to participate in the credit card debt category 24 times.

Based on the set up of the lottery gaming system 10, one of ordinary skill in the art will appreciate that a winner or winning ticket is selected and declared for each lottery game or level of participation. Unlike typical lottery games, the prize amount does not roll over to the next drawing if a winner is not selected.

The individual participating in the lottery gaming system may do so in a variety of ways and games, as shown in FIG. 2. In particular, FIG. 2 is an example of a chart 30 with various levels of participation associated with a lottery gaming system 10 for reducing debt of an individual in accordance with an aspect of the present disclosure. The table 30 illustrates that the lottery gaming system 10 may be divided up into one or more levels of participation 32 based on the desired wager amount 34 of the individual i.e. one or more different lottery games or more chances for an individual to play and win. The wager amount 34 may directly correspond to the winnings or prize amount 36 and is based on the total participation of individuals in that specific level. The wager amount 34 may range from $10.00 to $100.00 and the winnings or prize amount 36 may range from $25,000 to $250,000 depending on the level of participation. It is appreciated by one skilled in the art that the prize amount may exceed $250,000 depending on the level of participation within that lottery level. Similarly, the odds of winning 38 may directly correlate to the level of participation 32 within each lottery as well as the winnings or prize amount 36, as shown in FIG. 3. In one aspect, a threshold or certain levels of odds of winning are required before a ticket will be selected. In other words, there are a finite number of individuals that must participate to receive those certain odds. When a level of participation reaches its respective finite number of participants or individuals required to receive a certain level of odds, then the lottery is fully subscribed and a selection of a ticket is guaranteed. Unlike, current lottery games, the odds range in the lottery game discussed herein may be from 1 in 2875 to 1 in 9200. As a result, the likelihood of an individual winning the prize amount 36 increases and the odds the individual's debt is eliminated as well as a charitable organization receiving a donation also increases.

It is important to note that each lottery game with each level of participation may select a winning ticket for that level and corresponding odds multiple times a day. Thereby, increasing the individual's chance to play and chance to win. In other words, the more games available increase the individual's chances to participate, which in turn increase the individual's chance of winning and paying a portion or all of their debt.

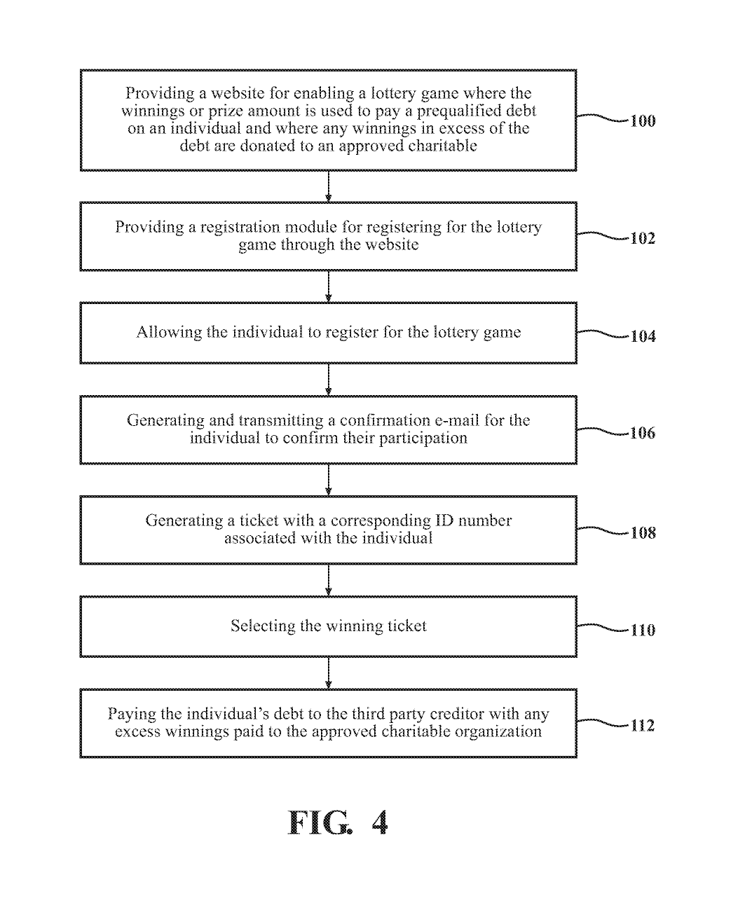

FIG. 4 is a flowchart of a method of reducing debt of an individual utilizing a lottery gaming system as described above in FIG. 1. The method may include providing a website for enabling a lottery game where the winnings or prize amount is used to pay a pre-qualified debt of an individual and where any winnings in excess of the debt are donated to an approved charitable 100. Specifically, the website may be accessed online through the internet, through a mobile application, or through a standalone kiosk operated by the individual or through an attendant.

The method may also include providing a registration module for registering for the lottery game through the website 102 and allowing the individual to register for the lottery game 104. In registering for the lottery game, the individuals may enter their personal information including, but not limited to, their name, address, phone number, and social security number. The individual may also provide their pre-qualified debt as discussed in FIG. 1 as well as the information associated with debt so that the lottery game can verify the debt to permit the individual to participate. The individual can further select an approved charitable organization to donate any excess winnings or prize amount to and may select the level of participation in the lottery including the specific lottery or drawing, wager, and odds.

Once the individual is registered 104, the lottery generates and transmits a confirmation e-mail for the individual to confirm their participation 106 as well as generates a ticket with a corresponding ID number associated with the individual's account 108. The lottery ticket may be a physical or electronic ticket. After a pre-determined amount of time, the lottery interface selects a winning ticket 110. To select the winning ticket 110, the lottery interface may electronically mix all tickets purchased for that particular game a pre-determined number of times and may eliminate half of the tickets before mixing the tickets again. After the tickets are mixed further, a portion of the remaining tickets are eliminated until ten numbers are left. From the ten numbers, a winning ticket is selected. If the individual's ticket is selected, then the individual wins the prize amount. The lottery game may directly pay the individual's debt to the third party creditor with any excess winnings paid to the approved charitable organization 112. If the individual's set of numbers does not match the winning set of numbers, the individual does not win and the individual's debt does not get paid.

The foregoing disclosure has been illustrated and described in accordance with the relevant legal standards, it is not intended that these examples illustrate and describe all possible forms of the invention, thus the description is exemplary rather than limiting in nature. Variations and modifications to the disclosed embodiment may become apparent to those skilled in the art and fall within the scope of the invention. Additionally, the features and various implementing embodiments may be combined to form further examples of the invention.

What is claimed:

1. A lottery gaming system for reducing debt of an individual through a lottery game associated with a wager amount and a prize amount corresponding to the wager amount, the lottery gaming system comprising:
a computer program for allowing the individual to participate and register for the lottery game executed on a processor,
the computer program includes,
a registration module for allowing the individual to select a pre-qualified debt associated with a creditor to receive the prize amount in the event the individual wins the lottery game and to select from a list approved charitable organizations to donate a remaining prize amount if the prize amount is greater than the pre-qualified debt,
wherein the registration module generates a ticket for the individual for participation in the lottery game,
a lottery module for selecting a winning ticket,
wherein if the individual's ticket is the winning ticket, the lottery gaming system transmits the prize amount to the creditor of the pre-qualified debt, and if the prize amount is greater than the pre-qualified debt, then the remaining prize amount is transmitted to the approved charitable organization.

2. The lottery gaming system of claim 1, wherein the registration module includes control logic allowing the individual to establish an account with the lottery gaming system.

3. The lottery gaming system of claim 1, wherein the registration module has a first menu for selecting the pre-qualified debt and the creditor associated with the pre-qualified debt.

4. The lottery gaming system of claim 1, wherein the registration module includes a second menu for selecting from the list of approved charitable organizations for donating the remaining prize amount from the lottery game.

5. The lottery game system of claim 1, wherein the registration module includes a third menu for selecting the at least one level of participation for engaging in the lottery game, and wherein the at least one level of participation is a plurality of levels of participation, each associated with different wager amounts and prize amounts.

6. The lottery gaming system of claim 1, wherein the pre-qualified debt includes at least one of credit card debt, mortgage, automobile, student loans, and medical expense debt.

7. The lottery gaming system of claim 1, further comprising:
an instruction module having control logic for displaying at least one of information and instructions for participating in the lottery game.

8. The lottery gaming system of claim 7, wherein information includes at least one of types of wagers, levels of participation, odds of winning based on the wager amount, pre-qualified debt, and approved charitable organization.

9. The lottery gaming system of claim 7, wherein instructions include at least one of operation of the lottery game, drawing the winning ticket, contacting the winning individual, payment of the prize amount, and terms and conditions for participation in the lottery game.

8. The lottery gaming system of claim 1, wherein the winning ticket is selected from a plurality of tickets based on the number of individuals participating in the lottery game.

9. The lottery gaming system of claim 8, wherein the lottery module includes a virtual hopper for electronically mixing the plurality of tickets.

10. The lottery gaming system of claim 9, wherein the virtual hopper electronically mixes the plurality of tickets at least one time before eliminating a pre-determined amount of the tickets.

11. A lottery gaming system for reducing debt of an individual, comprising:
a lottery game executed on a processor and having at least one level of participation, wherein each level of participation is associated with a pre-determined wager amount and a prize amount corresponding to the pre-determined wager,
wherein the individual registers for the lottery game by selecting the at least one level of participation, selecting a pre-qualified debt associated with an creditor, and selecting a pre-approved charitable organization, and
wherein the lottery game generates and provides a ticket to the individual based on the at least one level of participation, selects a winning ticket from a plurality of tickets, and transmits the prize amount to the creditor of the pre-qualified debt in response to individual's ticket being selected as the winning ticket, and wherein if the prize amount is greater than the individual's pre-qualified debt, then the remaining prize amount is transmitted to the charitable organization.

12. The lottery gaming system of claim 11, wherein the at least one level of participation is a plurality of levels of participation associated with a wager amount, a prize amount, and odds of winning.

13. The lottery gaming system of claim 11, wherein the individual registers for the lottery game through a registration module.

14. The lottery gaming system of claim 11, wherein the winning ticket selected from the plurality of tickets after the plurality of tickets are electronically mixed at least one time in a virtual hopper.

15. A method of reducing debt of an individual utilizing a lottery gaming system, the lottery gaming system includes a computer program executed on a processor for enabling a lottery game associated a wager amount and a prize amount corresponding to the wager amount, the method comprising the steps of:
providing a registration module for registering the individual for the lottery game, wherein the registration module allows the individual to select a creditor of a pre-qualified debt and an approved charitable organization;
generating a ticket associated with the individual for the lottery game;
selecting a winning ticket from a plurality of tickets;
determining if the ticket associated with the individual is the winning ticket;
transmitting the prize amount to the creditor of the pre-qualified debt to pay the individual's debt if the winning ticket is the ticket associated with the individual,
wherein if the prize amount is greater than the pre-qualified debt, then the remaining prize amount is transmitted to the approved charitable organization.

16. The method of claim 15, wherein selecting the winning ticket includes electronically mixing the plurality of tickets in a virtual hopper at least one time prior to selecting the winning ticket.

17. The method of claim 15, selecting the winning ticket includes electronically mixing the plurality of tickets in a virtual hopper two times prior to selecting the winning ticket.

18. The method of claim 16, wherein selecting the winning ticket includes eliminating 50% of the plurality of tickets after the plurality of tickets are mixed within the virtual hopper such that 50% of the plurality of tickets remain.

19. The method of claim 18, wherein the remaining 50% of the plurality of tickets are reduced until ten tickets remain.

20. The method of claim 19, wherein the winning ticket is selected from the ten remaining tickets.
